(19) United States
(12) Patent Application Publication
(10) Pub. No.: US 2021/0399358 A1
(43) Pub. Date: Dec. 23, 2021

(54) INTEGRATED COOLING ELEMENT FOR A BATTERY MODULE

(71) Applicant: Covestro Intellectual Property GmbH & Co. KG, Leverkusen (DE)

(72) Inventors: Matthias Knaupp, Langenfeld (DE); Julian Marschewski, Düsseldorf (DE)

(21) Appl. No.: 17/294,481

(22) PCT Filed: Nov. 13, 2019
(86) PCT No.: PCT/EP2019/081103

§ 371 Date: May 17, 2021

(30) Foreign Application Priority Data
Nov. 28, 2018 (EP) 18208973.0

(51) Int. Cl. H01M 10/653; H01M 10/613; H01M 10/6551; H01M 10/6556; H01M 10/643; H01M 10/6567; H01M 50/213; B29C 45/16

(52) U.S. Cl. CPC H01M 10/653; H01M 10/613; H01M 10/6551; H01M 10/6556; B29K 2101/12; H01M 10/6567; H01M 50/213; B29C 45/16; H01M 10/643

(57) ABSTRACT

A housing for at least one heat-releasing element (100), for example a battery element in an electric vehicle, comprises:
a housing wall (200),
a holder (300) which is joined to the housing wall (200) for accommodating the at least one heat-releasing element (100) and
a cooling body (400) which is arranged on a side of the housing wall (200) opposite the holder (300) and is joined to the housing wall (200).

The housing wall (200), the holder (300) and the cooling body (400) are together present as one-piece component, wherein the cooling body (400) has at least one channel (500) for a cooling medium and at least a subregion of the cooling body (400) consists of a first thermoplastic polymer composition having a thermal conductivity determined in accordance with ASTM E1461-01 of ≥0.2 W/(m K).

The present invention relates to a housing for at least one heat-releasing element, comprising a housing wall, a holder which is joined to the housing wall for accommodating the at least one heat-releasing element and a cooling body which is arranged on a side of the housing wall opposite the holder and is joined to the housing wall. The heat-releasing element is preferably a store for electric energy. The invention likewise relates to a vehicle, preferably an electric vehicle, having such a housing.

During operation of battery modules as are used in electric vehicles, the battery modules can heat up. The battery modules are therefore cooled to increase the life and to improve the efficiency.

Within a battery module, the battery cells are positioned and fixed in what are known as cell holders. These can, for example, be made of plastic. Underneath the cells, cooling usually occurs conventionally by means of a plate heat exchanger made of aluminum. In general, there are thus an upper part with the cells fixed in the cell holders and a lower part which realizes cooling. The heat-transferring area is ultimately a plate. The individual parts are clamped and integrated into the battery housing.

There are also variants in which cell holder and housing are made in one piece and cooling occurs conventionally underneath this by means of a plate heat exchanger made of aluminum.

DE 10 2014 201165 A1 relates to a battery module having a number of electrically connected battery cells, with the temperature of the individual battery cells being controlled by means of a heat transfer fluid. A channel system through which the heat transfer fluid flows runs between the battery cells and the channel system is separated from the battery cells by an outgassing system.

DE 10 2014 221684 A1 discloses a housing for accommodating a plurality of battery cells, in particular lithium ion battery cells, wherein the housing, in particular a plastic housing, comprises a cooling device having an entry position and an exit position for a stream of air for cooling the battery cells. The housing is, together with the cooling device integrated into the housing, configured as a one-piece component and the cooling device additionally has spacers for arranging all battery cells to be accommodated with an air-conducting intermediate space between the battery cells, as a result of which the air stream is provided with an air channel between the battery cells.

It is an object of the present invention to provide a housing for heat-releasing elements, which is simple to manufacture.

According to the invention, the object is achieved by a housing as claimed in claim 1. A process as claimed in claim 12 and a system as claimed in claim 13 are likewise provided by the invention. Advantageous further developments are indicated in the dependent claims. They can be combined with one another in any way as long as the context does not unambiguously indicate the contrary. Embodiments discussed in connection with the housing are also applicable to the process and the system.

A housing for at least one heat-releasing element comprises a housing wall, a holder which is joined to the housing wall for accommodating the at least one heat-releasing element and a cooling body which is arranged on a side of the housing wall opposite the holder and is joined to the housing wall. The housing wall, the holder and the cooling body are together present as one-piece component. The cooling body has at least one channel for a cooling medium. The cooling body consequently has a structure molded onto the housing wall. For the purposes of the present invention, “arranged on the opposite side of the housing wall” means that the cooling body is arranged on the outside of the housing while the holder is arranged in the interior of the housing. At least the material of the cooling body comprises a first thermoplastic polymer having a thermal conductivity determined in accordance with ASTM E1461-01 of ≥0.2 W/(m K). If “thermal conductivity” is spoken of in the present application, the through-plane thermal conductivity is always meant. For the present purposes, “polymer” is synonymous with “polymer composition”. Thus, at least one subregion of the cooling body consists of a thermoplastic composition having a thermal conductivity determined in accordance with ASTM E1461-01 of ≥0.2 W/(m K). Preference is given to the entire cooling body consisting of the first thermoplastic polymer composition.

The housing can easily be produced by injection molding since housing wall, holder and cooling body are together present as one piece. The thermal conductivity of the first thermoplastic polymer composition is preferably in the range from ≥0.2 W/(m K) to ≤20 W/(m K), more preferably from ≥0.3 W/(m K) to ≤16 W/(m K) and particularly preferably from ≥0.4 W/(m K) to ≤8 W/(m K).

The one-piece housing elements can be made of the same material. However, it is also possible to use different materials and then join these to one another by substance-to-substance bonding in order to obtain the one-piece housing. In order to remove heat, at least the material of the cooling body comprises the abovementioned thermally conductive thermoplastic polymer composition.

A process for producing a housing according to the invention comprises the step of production of the housing wall, the holder and the cooling body as one-piece component in an injection molding process. Here too, various materials or the same material overall (the first thermoplastic polymer composition) can be used.

As regards manufacture, all relevant parts can preferably be produced from two shots or even from only one shot. This simplifies the assembly of the module and manufacture.

A system comprises a housing according to the invention and a heat-releasing element which is accommodated in the holder of the housing. The heat-releasing element is preferably an electrochemical store for electric energy or an electrochemical source of electric energy. Particularly suitable stores are supercapacitors/ultracapacitors or rechargeable batteries such as rechargeable lithium-polymer batteries, and particularly suitable sources are fuel cells such as polymer electrolyte fuel cells and direct methanol fuel cells.

In one embodiment, the polymer of the first thermoplastic polymer composition is selected from among polycarbonate, polyamide, acrylonitrile-butadiene-styrene copolymers, polyphenylene sulfide, polypropylene or a mixture of at least two of the abovementioned polymers.

Preference is given to all elements participating in heat transfer consisting of polycarbonate-based material. A significant increase in the heat-transferring surface compared to conventional cooling can be achieved in this way. The use of similar materials is associated with similar coefficients of thermal expansion at the joins. In this way, it is possible for direct contact between materials to occur, so that the heat transfer resistances can be reduced compared to the known prior art. As regards the long-term stability, the dimensional accuracy of polycarbonate is also advantageous.

Preferred polycarbonates are aromatic polycarbonates, polycarbonates having a plurality of structural units derived from aromatic alcohols, polyester carbonates and blends comprising the abovementioned polycarbonates as main component. Preferred polycarbonates have weight-average molecular weights Mw of from 22 000 to 29 000 g/mol. Here, the Mw values are determined by gel permeation chromatography calibrated against bisphenol A polycarbonate standards using dichloromethane as eluent. The polycarbonates are preferably prepared by reactions of bisphenol compounds with carbonic acid compounds, in particular phosgene, or by the melt transesterification process using diphenyl carbonate or dimethyl carbonate.

Particular preference is given here to homopolycarbonates based on bisphenol A and copolycarbonates based on the monomers bisphenol A and 1,1-bis(4-hydroxyphenyl)-3,3,5-trimethylcyclohexane, e.g. Apec® from Covestro Deutschland AG.

Examples of preferred polyamides are PA-6,1, PA-6,T, PA-6,6, PA-6,6/6T, PA-6,6/6,T/6,1 copolyamide, PA-6,T/2-MPMDT copolyamide, PA-9,T, PA-4,6 and mixtures or copolyamides thereof.

In a further embodiment, the first thermoplastic polymer composition contains a polycarbonate which has a melt volume rate MVR of from 8 to 20 cm³/(10 min), determined in accordance with ISO 1133-1:2012-03 (300° C., 1.2 kg). This MVR is preferably from 15 to 20 cm³/(10 min).

In a further embodiment, the first thermoplastic polymer composition contains a filler from the group consisting of aluminum oxide, boron nitride, silicon oxide, kaolin, talc or a mixture of at least two of the abovementioned fillers. Such fillers serve to increase the thermal conductivity of the polymer composition. Of course, the first thermoplastic polymer composition can contain further additives such as stabilizers, flow improvers, mold release agents, UV absorbers, flame retardants and the like. Such a polymer containing additives can in total also be regarded as “first thermoplastic polymer”, i.e. no artificial difference is necessarily made between the macromolecules and the additives; “polymer” and “polymer composition” have the same meaning here. Preferred combinations are a polycarbonate with boron nitride, a polycarbonate with kaolin or a polycarbonate with talc.

The boron nitride used can be a cubic boron nitride, a hexagonal boron nitride, an amorphous boron nitride, a partially crystalline boron nitride, a turbostratic boron nitride, a wurtzitic boron nitride, a rhombohedral boron nitride and/or a further allotropic form, with preference being given to the hexagonal form.

The abovementioned thermally conductive fillers preferably have an agglomerated particle size (D(0.5) value) of from 1 μm to 100 μm, preferably from 3 μm to 60 μm and particularly preferably from 5 μm to 30 μm, determined by laser light scattering. In laser light scattering, particle size distributions are determined by measuring the angle dependence of the intensity of scattered light of a laser beam which passes through a dispersed particle sample. Here, the Mie theory of light scattering is used for calculating the particle size distribution. The D(0.5) value means that 50% by volume of all particles present in the material being examined are smaller than the value indicated.

If the housing according to the invention can be damaged by external effects during its use, for example as housing for rechargeable batteries in an electric vehicle, a very low electrical conductivity of the material increases safety. In the case of destruction or deformation of the housing, electrically conductive elements of the housing could otherwise short circuit the rechargeable batteries. For this reason, the first thermoplastic polymer composition is free of electrically conductive fillers in a further embodiment. Fillers to be avoided are, in particular, carbon black, graphene, fullerenes and carbon nanotubes.

In a further embodiment, the first thermoplastic polymer composition has a modulus of elasticity determined in accordance with ISO 527-1/-2 of from ≥2000 to ≤3500 MPa (preferably from ≥2500 to ≤3000 MPa) and/or an Izod impact toughness determined in accordance with ISO 180/A at 23° C. of from ≥5 to ≤60 kJ/m² (preferably from ≥10 to ≤50 kJ/m², more preferably from ≥20 to ≤40 kJ/m²). Polycarbonates having such mechanical properties in particular have advantages under crash or impact stresses. In the case of temporary stress peaks, the material does not fail suddenly in a brittle manner, but instead plastically. This contributes to the structural integrity of the component after overstressing. In contrast to materials which display brittle behavior and fail by fracture, the tough polycarbonate merely deforms.

The present invention will now be further illustrated with the aid of the following figures, but without being restricted thereto.

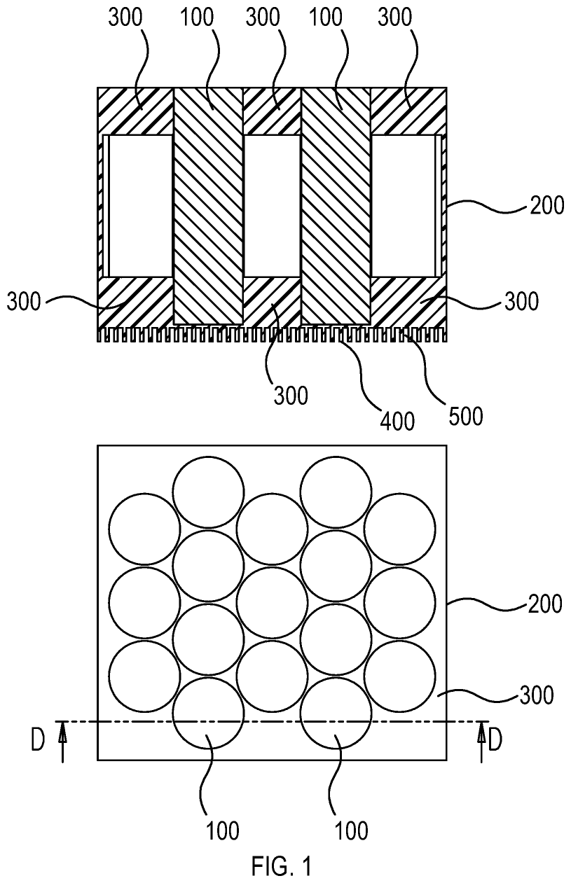

FIG. 1 shows a system according to the invention.

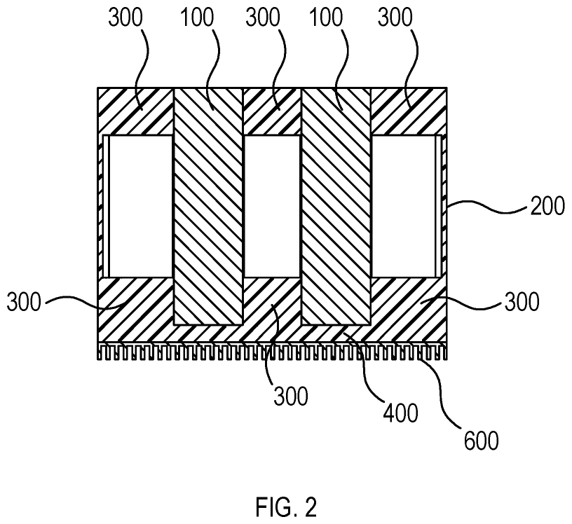

FIG. 2 shows a further system according to the invention.

FIG. 1 schematically shows a system according to the invention having a housing according to the invention which has accommodated heat-releasing elements 100, for example rechargeable batteries, in corresponding holders 300. The lower part of FIG. 1 shows the system in plan view and the upper part shows a sectional view along the line D-D drawn-in in the lower part.

The housing comprises, as one-piece component, the housing wall 200, a plurality of holders 300 and a cooling body 400. The holders 300 enclose the heat-releasing elements 100 at their upper and lower sections and thereby fix them in place. The cooling body 400 is arranged on a side of the housing wall 200 opposite the holders 300, in the present case on the underside of the housing. Owing to the one-piece nature, the formulation according to which the holders 300 go over into the housing wall 200 and the housing wall 200 goes over into the cooling body 400 at selected sections is equivalent.

The cooling body 400 has at least one channel 500 for a cooling medium. Preference is given to a) the at least one channel 500 for the cooling medium being a channel which is open to the surroundings and the cooling medium being air. This is depicted in FIG. 1. The side walls of the channel 500 can thus also be described as cooling fins. In an alternative b), the at least one channel 500 is a closed channel and the cooling medium is a liquid. Water cooling, for example, can be realized in this way.

In a further embodiment depicted in FIG. 2, the cooling body 400 is in two parts and has a subregion composed of a first thermoplastic composition and a subregion composed of a second thermoplastic composition, with the subregion composed of the first thermoplastic composition being planar on its side facing away from the holder 300 and this planar side being joined by substance-to-substance bonding to a region composed of a second thermoplastic composition 600.

In a further embodiment, the material of the housing comprises ≥90% by weight, based on the total weight of the housing, of the first thermoplastic polymer. Fillers and other polymer additives which are incorporated or have already been incorporated in the compounding of the polymer are included in this proportion by weight of the polymer (“polymer composition”). This proportion is preferably ≥95% by weight and more preferably ≥99% by weight, based on the total weight of the housing. The housing can thus be characterized as “one-component housing”. The use of only one material enables manufacturing steps to be saved.

In a further embodiment, the material of the housing further comprises a second thermoplastic polymer composition which is different from the first thermoplastic polymer composition and is present in sections of the housing at which the first thermoplastic polymer composition is absent. What has been said in respect of the first polymer composition also applies in principle to the second thermoplastic polymer composition. The polymer of the second thermoplastic polymer composition is preferably the same as the first, but with the thermally conductive fillers being decreased in amount or removed. In such a “two-component housing”, manufacturing requirements can generally be satisfied by thermoplastics which flow differently in the injection molding process being used at places on the housing at which good thermal conductivity is of lesser importance. The first and second thermoplastic polymer compositions together form a substance-to-substance bond at their interfaces.

In a further embodiment, the polymer of the second thermoplastic polymer composition is selected from among polycarbonate, polyamide, acrylonitrile-butadiene-styrene copolymers, polyphenylene sulfide, polypropylene or a mixture of at least two of the abovementioned polymers. To avoid repetition, reference may be made to what has been said above in respect of the first polymer composition.

In a further embodiment, the second thermoplastic polymer composition contains a flame retardant. Suitable flame retardants are, in particular, phosphates such as BDP (bisphenol A bis(diphenylphosphate)). Further suitable flame retardants are phosphazenes such as cyclic and linear phosphazenes of the formulae (I) and (II):

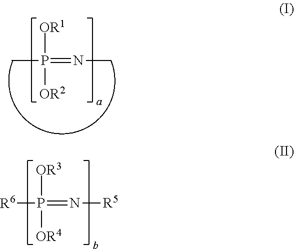

where R¹, R² are identical or different and are each an alkyl, cycloalkyl, aryl or alkylaryl, R³, R⁴ are identical or different and are each alkyl, cycloalkyl, aryl or alkylaryl, R⁵ is —N═P(OR³)₃, —N═P(OR⁴)₃, —N═P(O)OR³ or —N═P(O)OR⁴, R⁶ is —N═P(OR³)₄, —N═P(OR⁴)₄, —N═P(O)(OR³)₂ or —N═P(O)(OR⁴)₂, a is an integer in the range from 3 to 25 and b is an integer in the range from 3 to 10 000.

Among the cyclic phosphazenes of the formula (I) to be used according to the invention, preference is given to using those in which a in formula (I) is an integer in the range from 3 to 8, particularly preferably an integer in the range from 3 to 5.

Among the chain-like phosphazenes of the formula (II) to be used according to the invention, preference is given to using those in which b is an integer in the range from 3 to 1000, particularly preferably in the range from 3 to 100, very particularly preferably in the range from 3 to 25.

Very particular preference is given to using cyclic phenoxyphosphazenes as are obtainable from, for example, Fushimi Pharmaceutical Co. Ltd, Kagawa, Japan, under the name Rabitle® FP110 [CAS No. 1203646-63-2] or, when a=3, then 2,2,4,4,6,6-hexahydro-2,2,4,4,6,6-hexaphenoxytriazatriphosphorines [CAS No. 1184-10-7].

1. A housing for at least one heat-releasing element, comprising:
a housing wall,
a holder which is joined to the housing wall for accommodating the at least one heat-releasing element, and
a cooling body which is arranged on a side of the housing wall opposite the holder and is joined to the housing wall, wherein
the housing wall, the holder and the cooling body are together present as one-piece component, wherein the cooling body has at least one channel for a cooling medium and at least a subregion of the cooling body consists of a first thermoplastic polymer composition having a thermal conductivity determined in accordance with ASTM E1461-01 of ≥0.2 W/(m K).

2. The housing of claim 1, wherein the first thermoplastic polymer composition comprises a polymer selected from the group consisting of polycarbonate, polyamide, acrylonitrile-butadiene-styrene, polyphenylene sulfide, polypropylene and a mixture of at least two of the abovementioned polymers.

3. The housing of claim 2, wherein the first thermoplastic polymer composition comprises a polycarbonate which has a melt volume rate MVR of from 8 to 20 cm³/(10 min), determined in accordance with ISO 1133-1:2012-03 (300° C., 1.2 kg).

4. The housing of claim 1, wherein the first thermoplastic polymer composition further comprises a filler from the group consisting of aluminum oxide, boron nitride, silicon oxide, kaolin, talc or a mixture of at least two of the abovementioned fillers.

5. The housing of claim 1, wherein the first thermoplastic polymer composition has a modulus of elasticity determined in accordance with ISO 527-1/-2 of from ≥2000 to ≤3500 MPa or an Izod impact toughness determined in accordance with ISO 180/A at 23° C. of from ≥5 to ≤60 kJ/m2.

6. The housing of claim 1, wherein a) the at least one channel for the cooling medium is a channel which is open to the surroundings and the cooling medium is air or wherein b) the at least one channel is a closed channel and the cooling medium is a liquid.

7. The housing of claim 1, wherein the material of the housing contains ≥90% by weight, based on the total weight of the housing, of the first thermoplastic polymer composition.

8. The housing of claim 1, wherein the material of the housing further comprises a second thermoplastic polymer composition which is different from the first thermoplastic polymer composition and is present in regions of the housing in which the first thermoplastic polymer composition is absent.

9. The housing of claim 8, wherein the second thermoplastic polymer composition comprises polycarbonate, polyimide, acrylonitrile-butadiene-styrene copolymers, polyphenylene sulfide, polypropylene or a mixture of at least two of the abovementioned polymers.

10. The housing of claim 9, wherein the second thermoplastic polymer composition further comprises a flame retardant.

11. The housing of claim 1, wherein the cooling body has a plurality of channels which are formed by fins.

12. A process for producing the housing of claim 1, comprising the step of producing the housing wall, the holder (300) and the cooling body (400) as one-piece component in an injection molding process.

13. A system comprising the housing of claim 1 and a heat-releasing element which is accommodated in the holder of the housing.

14. The system of claim 13, wherein the heat-releasing element is an electrochemical store for electric energy or an electrochemical source of electric energy.
